(19) United States
(12) Patent Application Publication
(10) Pub. No.: US 2008/0172197 A1
(43) Pub. Date: Jul. 17, 2008

(54) SINGLE LASER MULTI-COLOR PROJECTION DISPLAY WITH QUANTUM DOT SCREEN

(75) Inventors: Andrew F. Skipor, West Chicago, IL (US); Marc K. Chason, Schaumburg, IL (US); William F. Hoffman, Palatine, IL (US); Krishna D. Jonnalagadda, Algonquin, IL (US); Mark A. Tarlton, Barrington, IL (US); George T. Valliath, Winnetka, IL (US); Jerzy Wielgus, Mount Prospect, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/622,190

(22) Filed: Jan. 11, 2007

(51) Int. Cl. G06F 19/00; G09G 3/34

(52) U.S. Cl. 702/82; 345/84

(57) ABSTRACT

A display (1100) comprises a passive screen (106, 502, 700, 1114) printed with a pattern (404) of different color quantum dots (602, 604, 606) that is excited by scanning a laser (130, 1108) over the screen (106, 502, 700, 1114). The display (1100) can be incorporated into a handheld device (100, 1200) to improve the use-ability of the device (100, 1200).

### FIELD OF THE INVENTION

The present invention relates generally to displays.

### BACKGROUND

The cathode ray tube (CRT) was the dominant television display from its introduction through the end of the 20^{th} century. In a CRT an electron beam passes from an electron beam gun through a hard vacuum to a phosphorescent screen. The electron beam is modulated with video information while it is scanned across the phosphor screen creating an image. The need for a hard vacuum within cathode ray tubes dictates using a heavy glass tube wall which makes increasing the screen size increasingly impractical beyond about 36 inches.

In the last few years a number of competing display technologies have been vying to supplant the CRT. Many of the competing display technologies can be grouped into a flat panel display category that includes both liquid crystal displays and plasma displays and a microdisplay projection category using liquid crystal and MEMS type spatial light modulators. Flat panel displays are costly because they require large area substrates to be patterned with active light elements. Projection microdisplays are costly because they require many different types of precision optics with expensive optical coatings. A less expensive display technology is needed.

Handheld electronic devices such as cellular telephone handsets, Personal Digital Assistants, and handheld game consoles have traditionally used liquid crystal displays. Recently the computer processing power of handheld devices has increased to a level that they are capable of running software applications that are ordinarily run on desktop or laptop computers. However, the small size of the displays of handheld electronic devices which is limited by the size of the handheld electronic devices makes using certain applications (e.g., web browsers, document editors) on handheld devices somewhat tedious. A solution to the size limitation of displays of handheld devices is needed.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIGS. 1-2 shown an example of a handheld electronic device that includes a scrollable laser energized light emitting screen;

FIG. 3 is a schematic cross-section of a functionalized core-shell quantum dot light emitter of the scrollable laser energized light emitting screen shown in FIGS. 1-2 according to certain embodiments of the invention;

FIG. 4 is a cross-sectional view of laser energized light emitting screen shown in FIGS. 1-2 according to certain embodiments of the invention;

FIG. 5-6 show a schematic view of rear projection display that uses a laser energized light emitting screen;

FIG. 7 shows a foldable laser energizable light emitting screen that includes multi-colored quantum dots;

FIG. 8 is a graph including absorption spectra for light emitting quantum dots of various sizes;

FIG. 9 is a graph including red, green and blue emission spectra for light emitting quantum dots in three size distributions;

FIG. 10 is a 1931.CIE color space diagram showing a color gamut that can be covered with the emission spectra shown in FIG. 9;

FIG. 11 is a block diagram of a display that uses a laser to excite a screen patterned with quantum dots; and

FIGS. 12-13 shown an alternative variation of the handheld device shown in FIGS. 1-2.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to displays. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of displays described herein. The non-processor circuits may include, but are not limited to, a radio receiver, a radio transmitter, signal drivers, clock circuits, power source circuits, and user input devices. As such, these functions may be interpreted as steps of a method to perform image signal processing. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

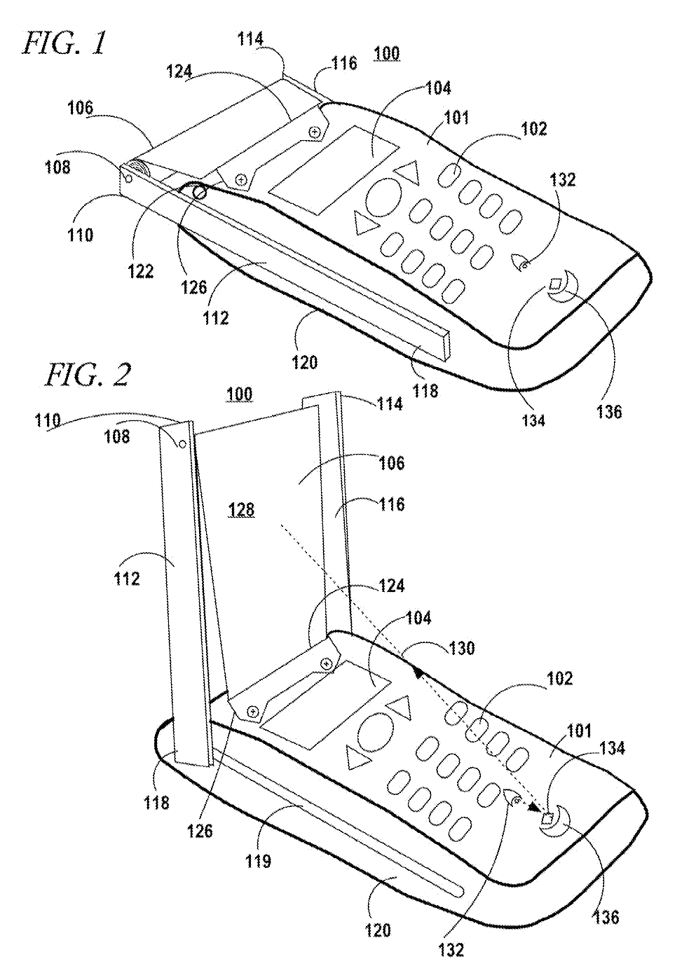

FIGS. 1-2 shown an example of a handheld electronic device 100 that includes a scrollable laser energized light emitting screen 106. As shown in FIGS. 1-2 the device 100 comprises a cellular telephone handset, however it will be apparent to persons of ordinary skill in the art that the teachings hereinbelow may be applied to other devices, including, but not limited to PDA's, handheld game consoles, handheld GPS units and portable data terminals. Referring to FIGS. 1-2 the device 100 comprises a housing 101 supporting and enclosing a keypad 102 and a built-in display 104 which are typical of handheld electronic devices. However, the device 100 also has the light energizable, light emissive, deployable scrollable screen 106. As shown in FIG. 1 (in an undeployed state) the screen 106 is rolled on an axel 108 that is supported between a distal end 110 of a first support arm 112 and a distal end 114 of a second support arm 116. The axel 108 can be spring loaded by a torsional spring (not shown) so as to tend to wind the screen 106 into the rolled up condition shown in FIG. 1. A proximal end 118 of the first support arm 112 includes a peg (not shown) engaged in a first track 119 that runs along a near side 120 of the housing 101 of the device 100. A proximal end (not shown) of the second support arm 116 includes another peg that runs in a second track that runs along an opposite side of the housing 101 of the device 100. A locking detent 122 in the side 120 of the housing 101 engages a complementary recess (not shown) in the first support arm 112.

A free end 124 (not attached to the axel 108) of the screen 106 is clamped to the housing 101 by a clamp 126. Thus, when the support arms 112, 116 are lifted with the axel 108 to the upright position shown in FIG. 2, the screen 106 is unrolled from the axel 108 presenting its full front surface 128 that is, towards keyboard 102. The front surface 128 is coated with a coating that includes quantum dots. The coating can be bonded to the surface by hydrogen bonding, covalent bonding or other bonding. According to certain embodiments, the front surface 128 has a pattern of quantum dots that emit different colors of light, (e.g., red, blue and green, or a higher number of colors) so that color images can be displayed.

The pattern of quantum dots can be deposited on the screen 106 by printing, including but not limited to such printing techniques as Flexo, Gravure, Screen and inkjet printing. The quantum dots are added to the printing ink in lieu of pigment.

A laser (e.g., a GaN ultraviolet laser diode, not visible in the FIGs) is accommodated within the housing 101 such that a laser beam 130 of the laser is emitted through a first port 132 in the housing 101. The beam 130 is reflected by a 2-D Micro-Electro-Mechanical System (MEMS) scan mirror 134 that is situated in a second port 136 that faces the first port 132. The scan mirror 134 scans the laser beam 130 over the front surface 128 of the screen 106, e.g., in a raster or vector pattern. While the laser beam 130 is scanned over the surface 128 of the screen 106 it is modulated based on digital image information (e.g., pixel brightness values) so as to excite quantum dots on the surface 128 of the screen 106 to varying degrees and thereby form a viewable image. It will be apparent to persons of ordinary skill in the art that the arrangement of the mirror 134 and laser beam 130 may be varied within the constraints imposed by optics.

According to an alternative embodiment the axel 108 is accommodated within the housing 101 and the free end 124 of the screen 106 is attached to the distal ends 110, 114 of the support arms 112, 116.

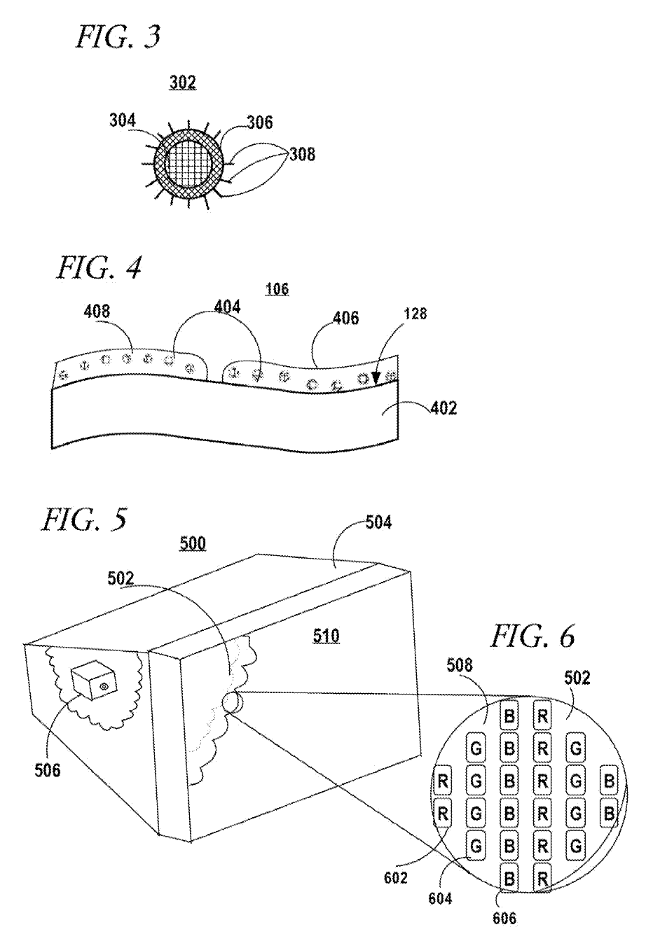

FIG. 3 is a schematic cross-section of a functionalized core-shell quantum dot light emitter of the scrollable laser energized light emitting screen shown in FIGS. 1-2 according to certain embodiments of the invention. The quantum dot 302 includes a core 304 and a shell 306. The shell 306 is made of a material that has a higher band gap than a material of the core 304. Using a higher band gap shell reduces a rate of non-radiative transitions thereby increasing the efficiency and brightness of the quantum dot 302. The core 304 can, for example, be made of CdS, CdSe, CdTe, ZnS, ZnSe, ZnTe, GaAs, GaP, GaAs, GaSb, HgS, HgSe, HgTe, InAs, InP, InSb, AlAs, AlP, AlSb, whilst the shell 306 can, for example be made of ZnO, ZnS, ZnSe, ZnTe, CdO, CdS, CdSe, CdTe, MgS, MgSe, GaAs, GaN, GaP, GaAs, GaSb, HgO, HgS, HgSe, HgTe, InAs, InN, InP, InSb, AlAs, AlN, AlP, AlSb. Alternative quantum dot materials that may be used include but are not limited to tertiary microcrystals such as InGaP, which emits in the yellow to red wavelengths (depending on the size) and ZnSeTe, ZnCdS, ZnCdSe, and CdSeS which emits from blue to green wavelengths, (depending upon the size) Additional alternative materials that may be used in quantum dots include Zinc chalcogenides, such as ZnSe, doped with transition metal ions such as Mn or Cu.

The quantum dot 302 is capped (functionalized) with molecules 308. In as much as quantum dots are prepared in colloidal systems a variety of molecules can be attached to them via metal coordinating functional groups, including thiols, amines, nitriles, phosphines, phosphine oxides, phosphonic acids, carboxylic acids or others ligands. With appropriate molecules bonded to the surface, the quantum dots could be readily included in different resin systems, without degrading their quantum electronic properties (e.g., emission efficiency). The molecules 308 render the quantum dot 302 miscible with a resin that is used to hold the quantum dot in place on the screen 106. The resin can be heat dryable or include a UV curable photochemical resin, for example.

FIG. 4 is a cross-sectional view of the laser energized light emitting screen 106 shown in FIGS. 1-2 according to certain embodiments of the invention. The screen 106 comprises a flexible, rollable substrate 402. The substrate can be made out of a variety of materials including but not limited to, cloth, paper, a polymeric film on paper, polyesters, polyimides, polyamides, polyamide-imides, polyetherimides, polyacrylates, polyethylene terephthalate, polyethylene, polypropylene, polyvinylidene chloride, and polysiloxanes. A pattern 404 of quantum dots dispersed in a resin binder is printed on the substrate 402. The pattern 404 includes distinct areas 406, 408 that have different mean quantum dot sizes and thus emit different colors of light when excited with laser light. For example, a first area 406 has larger quantum dots than a second area 408 and therefore emits longer wavelength visible light. The first area 406 can serve as a sub-pixel for one color (e.g., red) and the second area 408 as a sub-pixel for a second color (e.g., green). The resin binder can for example comprise: silicone poly-silicone, urethanes, poly-urethanes, acrylics, epoxies, thermoset and thermoplastics. Alternatively, quantum dots made of different materials but with overlapping size distribution are used to obtain different colors. Alternatively, a thin protective coating (not shown) can be formed overlying the pattern 404 of quantum dots. According to another alternative the pattern 404 of quantum dots is on a back surface of the substrate 402 and is excited by the laser beam 130 through the surface.

FIG. 5-6 show a schematic view of rear projection display 500 that uses a laser energized light emitting screen 502. The display 500 includes an enclosure 504 that encloses a laser projector 506. The laser projector 506 includes a laser, such as a GaN laser diode and 2-D beam scanner such as a 2-D MEMS scanner. The laser energized light emitting screen 502 serves as a front wall of the enclosure 504. As shown in the magnified view of the screen 502 shown in FIG. 6 the screen 502 includes a substrate 508 printed with a pattern of red 602, green 604 and blue 606 quantum dots in a binder. Different color quantum dots are arranged in a parallel stripe pattern, so when the laser projector 506 is operated to scan a laser beam perpendicular to the strip pattern the laser beam will pass through red, blue and green quantum dot areas in rapid succession. The quantum dot areas of each color serve as sub-pixels for generating primary colored light. An absorbing plastic filter 510 is positioned in front of the light emitting screen 502. The filter 510 stops laser light from reaching persons viewing the display 500. In particular if the laser projector 506 emits ultraviolet light the filter blocks ultraviolet light.

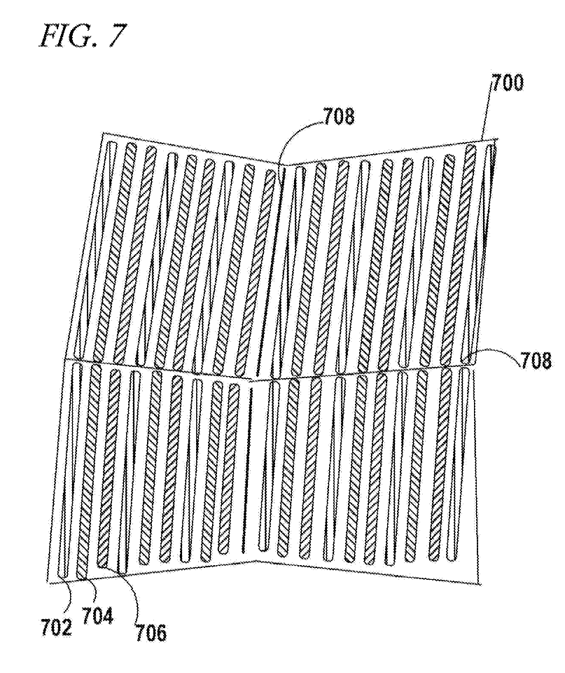

FIG. 7 shows a foldable laser energizable light emitting screen 700 that includes a colored strip pattern of quantum dots. The strip pattern includes red 702, green 704, and blue quantum dots 706. The screen includes prefold lines 708 to facilitate folding and unfolding of the screen. The screen 700 can be used with a handheld device similar to that shown in FIGS. 1-2 but that does not include the built-in deployable scrollable screen 106.

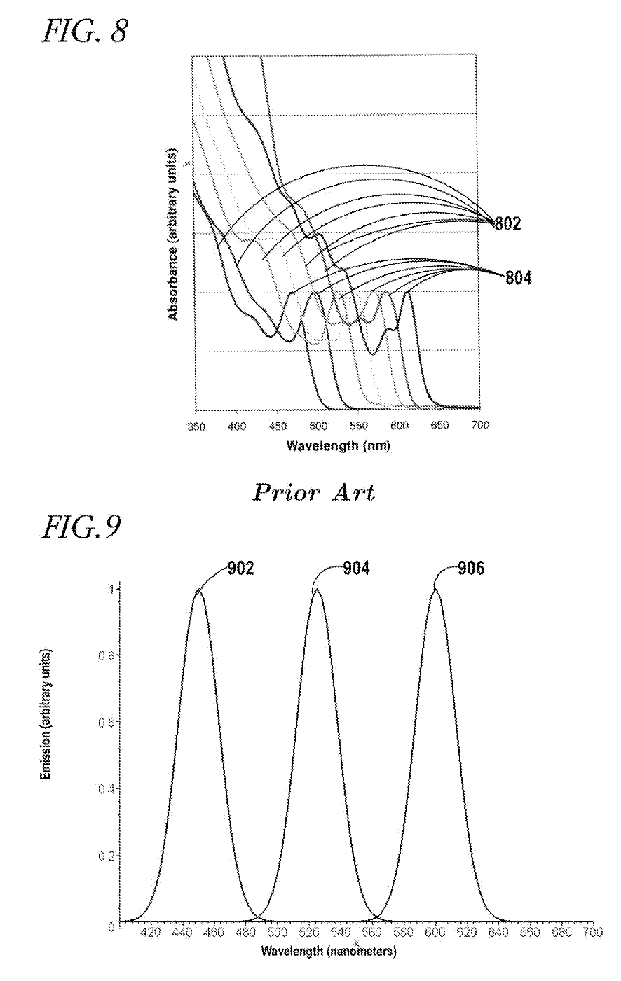

FIG. 8 is a graph 800 including absorption spectra for light emitting quantum dots of various sizes. The graph 800 shows excitation light absorbance versus wavelength for several sizes of quantum dots that emit visible light. The graph 800 includes plots 802 for different sizes of quantum dots. Each plot 802 includes a local peak 804 that corresponds to its peak emission wavelength. As shown in FIG. 8 all of the quantum dots represented in the plots 802 are able to effectively absorb pump light in the UVA range.

FIG. 9 is a graph 900 including red, green and blue emission spectra for light emitting quantum dots in three size distributions. FIG. 9 includes three lines 902, 904, 906 of spectral emission for three size distributions of quantum dots. The lines 902, 904, 906 exhibit Gaussian line shapes that have a FWHM of 30 nm. The spectral FWHM is a function of the size distribution FWHM. A first blue line 902, is centered at 450 nm, a second green line 904 is centered at 525 nanometers and a third red line 906 is centered at 600 nanometers.

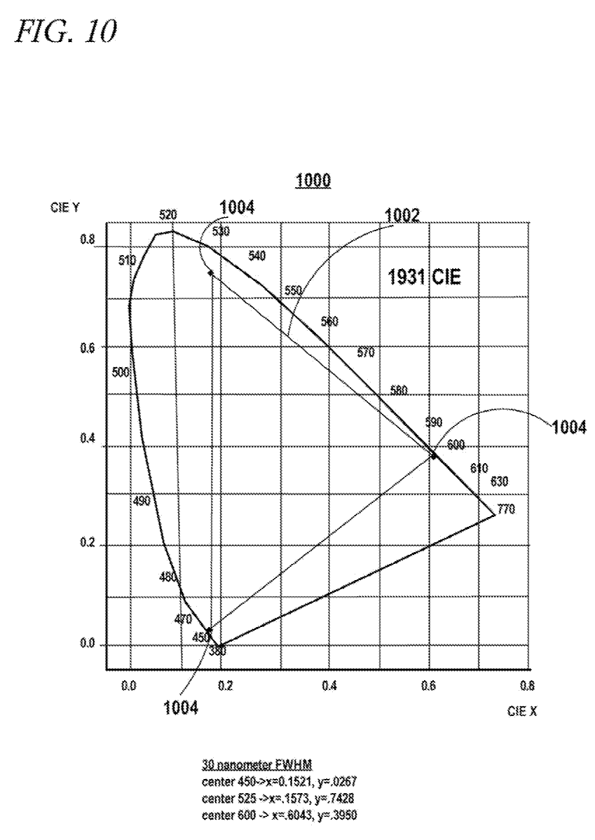

FIG. 10 is a 1931.CIE color space diagram showing a color gamut that can be covered with the emission spectra shown in FIG. 9. One skilled in the art will appreciate that the use of quantum dots allows for fine control of the obtainable color space by controlling the center and FWHM of quantum dot size distributions used in the quantum dot ink 102. Although as shown in FIG. 9 only three color space points 704 are used to delineate the obtained color range 702, one skilled in the art will appreciate that an expanded color range can be obtained by using more than three quantum dot sub-pixels, with each sub-pixel having a different mean quantum dot size.

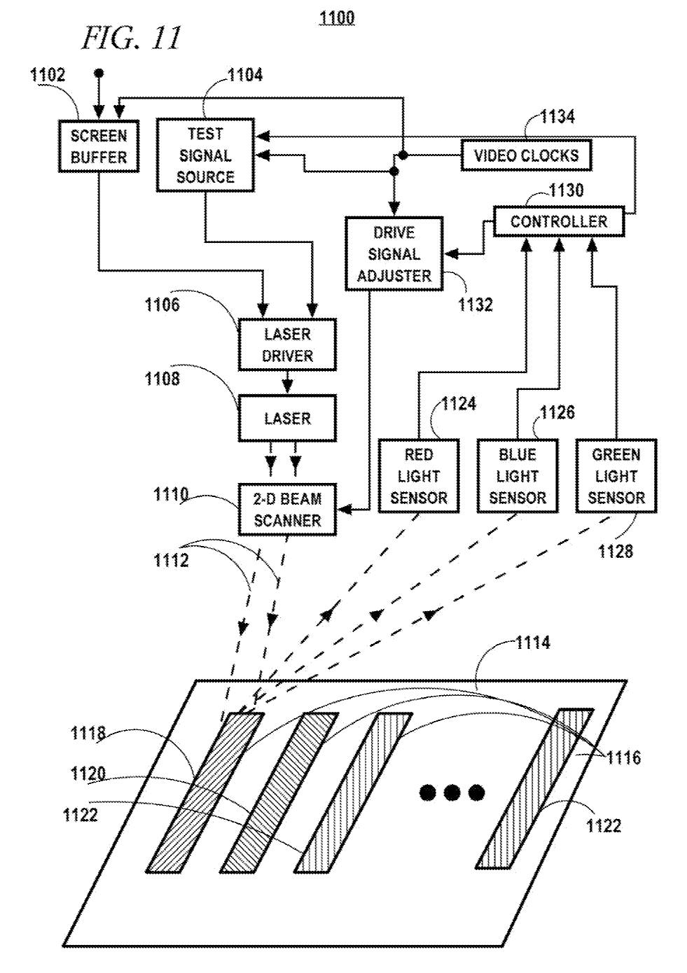

FIG. 11 is a block diagram of a display system 1100 that uses a laser 1108 to excite a screen patterned with quantum dots. A screen buffer 1102 is an entry point into the system. Image and video data is input at the screen buffer 1102. The screen buffer and a test signal source 1104 feed pixel brightness data to a laser driver 1106. The test signal source 1104 can be used for alignment calibration. The test signal source can output a simple structured video test signal, such as for example only pixels of one color at a predetermined intensity. The laser driver 1106 suitably includes a video digital-to-analog converter followed by a video bandwidth amplifier (not shown). The laser driver 1106 is coupled to the laser 1108. The laser driver 1106 drivers the laser 1108 with a signal modulated based on video information received from the screen buffer or the test signal source 1104. The laser 1108 is optically coupled to a 2-D beam scanner 1110. The 2-D beam scanner 1110 suitably comprises a 2-D MEMS device, an arrangement of two faceted rotating mirrors in sequence, a piezoelectric device, or an electro-optic device for example. A laser beam 1112 emitted by the laser 1108 is scanned (typically in a raster scan pattern, but alternatively in a vector scan mode) by the beam scanner 1110 over a screen 1114 printed with a pattern of quantum dots 1116.

As shown in FIG. 11 the pattern of quantum dots 1116 includes a series of parallel lines included red lines 1118, green lines 1120, and blue lines 1122. Although only a few parallel lines of quantum dots are shown in FIG. 11, it should be understood that in practice there will be a large number e.g., 512, 1024, that is selected to achieve a desired screen resolution. Note that the parallel lines 1118, 1120, 1122 can be oriented parallel to or perpendicular to a line scan direction of the raster scan pattern. In the former case, vertical laser beam alignment is more critical and in the latter case horizontal laser beam alignment is more critical. Alternatively, other pixel patterns are used in lieu of parallel lines. The screen 1114 can be made somewhat larger (e.g., by 5%) than needed to make the system 1110 more tolerant of gross (e.g., within 5%) alignment errors. However, there then remains an issue of sub-pixel alignment, in other words the system 1100 must be adjusted so that when the laser 1108 is being driven based on green pixel information, for example, the 2-D beam scanner 1110 must be pointing at one of the green lines 1120 in the pattern of quantum dots 1116.

One way to handle sub-pixel alignment is to use a red light sensor 1124, a green light sensor 1126, and a blue light sensor 1128 to sense light emitted by the pattern of quantum dots 1116. The sensors include filters that selectively pass red, blue and green light, respectively. The light sensors 1124, 1126, 1128 are coupled to a controller 1130. The controller 1130 is also coupled to the test signal source 1104 and to one or more drive signal adjusters 1132. One or more video clocks 1134 are coupled though the drive signal adjusters 1132 to the 2-D beam scanner 1110. The drive signal adjusters 1132 control the phase and/or amplitude of signals to the 2-D beam scanner under control of the controller 1130. The video clocks 1134 are also coupled to the test signal source 1104 and the screen buffer 1102 so that pixel data can be supplied from the test signal source 1104 and the screen buffer 1104 in synchrony with scanning of the laser beam 1112. Alternatively, the signal adjusters 1132 can be interposed between the video clocks 1134 and the screen buffer 1102 and test signal source 1104. Gross beam alignment is suitably achieved by synchronizing the 2-D beam scanner 1110 with a frame start signal from the video clocks 1134. Then in order to achieve sub-pixel alignment pre-determined test signal (e.g., an array of green dots) is used to drive the laser 1108, while the light sensors 1124, 1126, 1128 are used to detect the color of light emitted by the screen 1114 in response to the laser excitation, and the drive signal adjusters 1132 are used to adjust drive signal phase in order to align the laser beam on the green lines 1120 of the pattern of quantum dots 1116 and maximize green light emission. Alternatively, or additionally the foregoing procedure can be conducted for red and blue. To handle the possibility that the screen 1114 is rotated about the optical axis (perpendicular to screen) the required phase adjustment may be performed for each or several spaced horizontal (or vertical) lines, and multiple phase adjustments can be determined and stored in the controller 1130 and subsequently read out and sequentially applied to the drive signal phase shifters 1132 during each frame, so that a proper phase adjustment will be used at each vertical (or horizontal) position of the screen. The necessary phase adjustment can be interpolated for vertical (or horizontal) positions at which it has not been measured. Alternatively, manual sub-pixel alignment controls are provided so that a user can adjust the alignment. In a system where the distance between the screen 1114 and the scanner 1110 is not fixed, it may be necessary to use the drive signal adjuster 1132 to adjust the amplitude of signals driving the 2-D beam scanner 1110 so that the angular scan range of the scanner corresponds to the angular extent of the screen (which in turn depends on its distance). The angular extent of the screen can be ascertained by driving the laser continuously, while using the scanner 1110 to sweep the laser beam 1112 through a small predetermined angle range while counting the number of light pulses received by one or more of the sensors 1124, 1126, 1128. Then knowing the number of pixels for the full display (e.g., 512, 1024) the full angular extent of the screen can be deduced by using proportional arithmetic programmed into the controller 1130. Then, the controller can control the drive signal adjuster 1132 to scale the drive signals for the 2-D beam scanner 1110 accordingly.

The system 1100 can be scaled up in terms of laser power and screen size for use in home theaters or even commercial/public movie theaters.

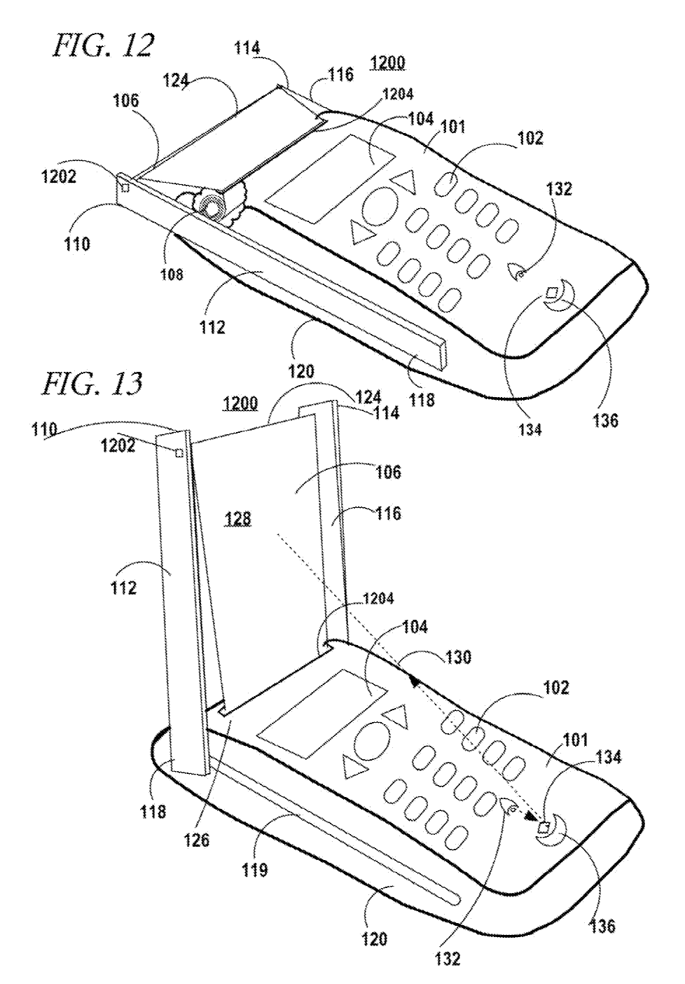

FIGS. 12-13 shows an alternative variation 1200 of the handheld device shown in FIGS. 1-2. In the alternative device 1200, the axel 108 is disposed within the housing 101 and when the screen 106 is undeployed it is wound around the axel 108 within the housing 101. The housing 101 is shown cut-away in FIG. 12 to show the screen 106 wound on the axel 108. The free end 124 of the screen 106 is attached to a bar 1202 that extends between the distal ends 110, 114 of the support arms 112, 116. The screen 106 deploys through a slot 1204 in the housing 101. The mechanical designs of the handheld devices 100, 1200 with deployable screen 106 can also be used with reflective (non-emissive) screens and visible light (e.g., three color) laser beams.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A light emissive display screen comprising:
a substrate;
a multi-colored pattern of quantum dots on said substrate.

2. The light emissive display screen according to claim 1 wherein said quantum dots comprise a core and a shell.

3. The light emissive display screen according to claim 1 wherein said substrate is flexible.

4. The light emissive display screen according to claim 3 wherein said substrate comprises a material selected from the group consisting of: paper, polyesters, polyimides, polyamides, polyamide-imides, polyetherimides, polyacrylates, polyethylene terephthalate, polyethylene, polypropylene, polyvinylidene chloride, and polysiloxanes.

5. The light emissive display according to claim 1 wherein said quantum dots are dispersed in a binder.

6. The light emissive display according to claim 5 wherein said binder comprises a photochemical resin.

7. A display comprising:
a screen comprising:
a substrate; and
a pattern of quantum dots on said substrate;
a laser adapted to produce a laser beam;
a beam scanner optically coupled to said laser, wherein said beam scanner is adapted to scan said laser beam over said screen;
laser drive electronics drivingly coupled to said laser, wherein said laser drive electronics are adapted to modulate said laser according to image information.

8. The display according to claim 7 wherein said screen is scrollable.

9. The display according to claim 7 wherein said screen is foldable.

10. The display according to claim 7 wherein said screen is rollable.

11. The display according to claim 7 wherein:
said quantum dots are functionalized with molecules.

12. The display according to claim 7 wherein:
said quantum dots comprise:
a core; and
a shell.

13. The display according to claim 12 wherein said quantum dots are made out of one or more materials selected from the group consisting of: CdS, CdSe, CdTe, ZnS, ZnSe, ZnTe, GaAs, GaP, GaAs, GaSb, HgS, HgSe, HgTe, InAs, InP, InSb, AlAs, AlP, AlSb, ZnO, ZnS, ZnSe, ZnTe, CdO, CdS, CdSe, CdTe, MgS, MgSe, GaAs, GaN, GaP, GaAs, GaSb, HgO, HgS, HgSe, HgTe, InAs, InN, InP, InSb, AlAs, AlN, AlP, AlSb, ZnSeTe, ZnCdS, ZnCdSe, CdSeS ZnSe doped with Mn and ZnSe doped with Cu.

14. A method of aligning an excitation laser beam with a multi-colored pattern of quantum dots, the method comprising:
raster scanning said excitation laser beam over said multi-colored pattern of quantum dots;
sensing light emitted by said multi-colored pattern of quantum dots with a light sensor in order to obtain a light reading;
adjusting at least one signal used to synchronize said raster scanning with said multi-colored pattern of quantum dots based on said light reading.

15. The method according to claim 14 further comprising:
modulating said excitation laser to illuminate only one color of said multi-colored pattern of quantum dots;
filtering light sensed by said sensor with a filter that passes light emitted by said only one color of said multi-colored pattern of quantum dots; and
wherein adjusting said at least one signal comprises adjusting said at least one signal in order to maximize said light reading.

16. The method according to claim 14 further comprising:
scanning said excitation laser beam over an angular range,
counting a number of pulses of light sensed by said sensor; and
wherein adjusting said at least one signal comprises scaling said at least one signal.

17. A portable device comprising:
a screen comprising:
a flexible substrate; and
a pattern of quantum dots printed on said substrate;
a laser adapted to produce a laser beam;
a beam scanner optically coupled to said laser, wherein said beam scanner is adapted to scan said laser beam over said screen;
laser drive electronics drivingly coupled to said laser, wherein said laser drive electronics are adapted to modulate said laser according to image information.

18. The portable device according to claim 17 further comprising an axel wherein said screen is attached to said axel such that said screen can be rolled on said axel and unrolled from said axel.

19. A portable device comprising:
a housing;
a first support arm that is coupled to said housing and extendable from said housing, said first support arm comprising a first distal end;
an axel;
a projection screen that is rolled on said axel and unrollable from said axel, wherein, in an unrolled state said screen extends between said housing and said first distal end of said first support arm;
a laser for scanning a laser beam over said projection screen.

20. The portable device according to claim 19 wherein said axel is coupled to said first distal end of said first support arm.

21. The portable device according claim 19 wherein said axel is disposed within said housing.

22. The portable device according to claim 19 comprising a second support arm that is coupled to said housing and extendable from said housing, second support arm comprising a second distal end; and
wherein in said unrolled state said projection screen extends between said housing and said second distal end of said second support arm.
